(19) United States
(12) Patent Application Publication
(10) Pub. No.: US 2024/0353739 A1
(43) Pub. Date: Oct. 24, 2024

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: AKIHIKO SATO, Kanagawa (JP); TAKUMA YANAGISAWA, Tokyo (JP); KUYA NISHIZUMI, Kanagawa (JP); SHIGEO AJIRO, Kanagawa (JP)

(21) Appl. No.: 18/763,606

(22) Filed: Jul. 3, 2024

Related U.S. Application Data
(63) Continuation of application No. PCT/JP2022/047854, filed on Dec. 26, 2022.

(30) Foreign Application Priority Data
Feb. 3, 2022 (JP) 2022-015820

(51) Int. Cl. G03B 15/16; G06T 11/80; H04N 23/60

(52) U.S. Cl. CPC G03B 15/16; G06T 11/80; H04N 23/60

(57) ABSTRACT

An image processing apparatus acquires first image content and a degree of fluctuation of a fluctuation element of the first image content, the fluctuation element being an element having fluctuation as a state variation, out of elements constituting an image. The apparatus acquires information indicating a shooting intent of a user, and generates second image content having a different degree of fluctuation of a fluctuation element of the image content from the first image content, using a trained learning model. The learning model generates the second image content in which the degree of fluctuation acquired from the first image content corresponds to the information indicating the shooting intent.

### CROSS-REFERENCE TO RELATED APPLICATIONS

This application is a Continuation of International Patent Application No. PCT/JP2022/047854, filed Dec. 26, 2022, which claims the benefit of Japanese Patent Application No. 2022-015820, filed Feb. 3, 2022, both of which are hereby incorporated by reference herein in their entirety.

### BACKGROUND OF THE INVENTION

### Field of the Invention

The present invention relates to an image processing apparatus, an image processing method, and a storage medium.

### Background Art

It is known that shooting action includes the aspect of “recording” a shooting target as image content, and the aspect of “expressing” what a photographer wishes to convey through image content. In a case where shooting action emphasizes “expression” through image content, it is particularly important that the intent of the photographer (referred to as “content acquisition intent” hereinafter) is reflected in the content. Meanwhile, in an actual scene for shooting, facial expressions and motion of subjects, positional relationships between subjects, and the like often do not match the intent of the photographer, and thus the photographer needs to wait until subject's conditions match the content acquisition intent and concentrate at all times so as not to miss a shot.

On the other hand, in a case where emphasis is placed on “expression” through image content, the necessity for the obtained image content to be an “image content obtained by a photographer through shooting action” is diminished. PTL 1 proposes a technique for generating aggregated content for providing a rich retrospective experience including atmosphere using shot images or video content. Also, a technique using a deep neural network model using a generative adversarial network (GAN) has been proposed as a technique for generating non-existent image content. PTL 2 proposes a technique for generating an image in which the direction of the line of sight or the orientation of a face is changed using a trained GAN model.

### CITATION LIST

### Patent Literature

PTL 1: Japanese Patent Laid-Open No. 2016-51270
PTL 2: Japanese Patent Laid-Open No. 2019-148980

In the technique proposed in PTL 1, in a case where the content acquisition intent is not reflected in the original image or video content, the content acquisition intent cannot be reflected in aggregated content generated using the image or the like. Also, the technique proposed in PTL 2 is a technique for generating an image in which the direction of the line of sight or the orientation of a face is changed, and generation of content that reflects the content acquisition intent of the image content is not considered.

The present invention has been made in view of the above-mentioned issues, and aims to realize a technique by which it is possible to obtain an image content that more appropriately reflects a content acquisition intent.

### SUMMARY OF THE INVENTION

In order to resolve these issues, for example, an image processing apparatus according to the present invention includes a configuration below. Specifically, the image processing apparatus is characterized by including: content acquisition means for acquiring first image content; degree acquisition means for acquiring a degree of fluctuation of a fluctuation element of the first image content, the fluctuation element being an element having fluctuation as a state variation, out of elements constituting an image; intent acquisition means for acquiring information indicating a shooting intent of a user; and generation means for generating second image content having a different degree of fluctuation of a fluctuation element of image content from the first image content, using a trained learning model, in which the learning model generates the second image content in which the degree of fluctuation acquired from the first image content corresponds to the information indicating the shooting intent.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a block diagram showing an example of the functional configuration of an image processing apparatus according to an embodiment.

FIG. 1B is a block diagram showing an example of the hardware configuration of an image processing apparatus according to an embodiment.

FIG. 2 is a diagram illustrating fluctuation of elements constituting image content according to an embodiment.

FIG. 3 is a flowchart showing operation of fluctuation model training processing according to an embodiment.

FIG. 4 is a flowchart showing operation of image content generation processing (reconstruction processing) according to an embodiment.

FIG. 5A is a diagram (1) illustrating an example of image content fluctuation rule generation according to an embodiment.

FIG. 5B is a diagram (2) illustrating an example of image content fluctuation rule generation according to an embodiment.

FIG. 5C is a diagram (3) illustrating an example of image content fluctuation rule generation according to an embodiment.

FIG. 5D is a diagram (4) illustrating an example of image content fluctuation rule generation according to an embodiment.

FIG. 6 is a diagram showing an example of image content generation according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

An example in which a digital camera capable of generating image content is used as an example of an image processing apparatus will be described below. However, this embodiment is applicable not only to digital cameras but also to other devices capable of generating image content. Examples of these devices include mobile phones including smartphones, game consoles, personal computers, tablet terminals, other wearable information terminals, and server devices.

### Example of Functional Configuration of Digital Camera

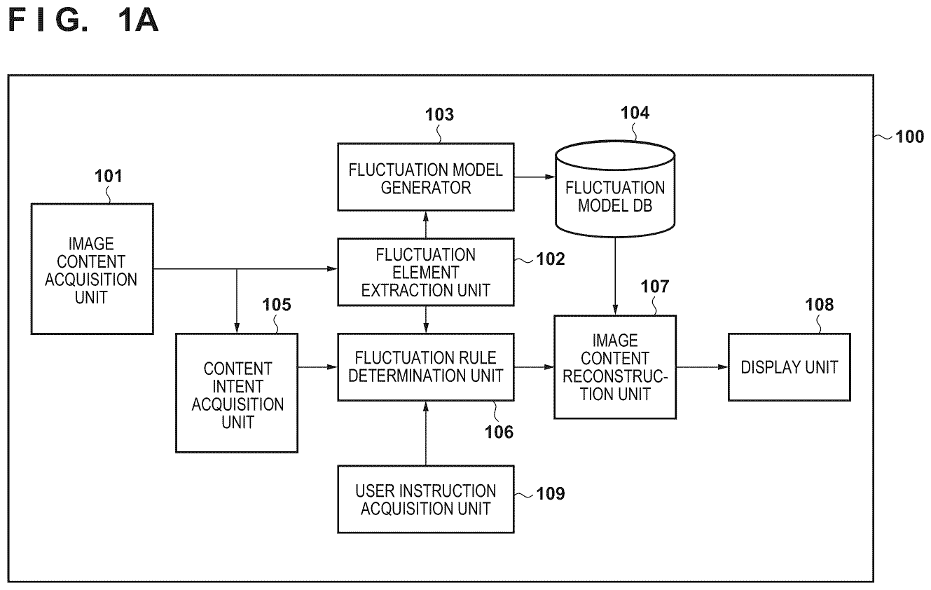

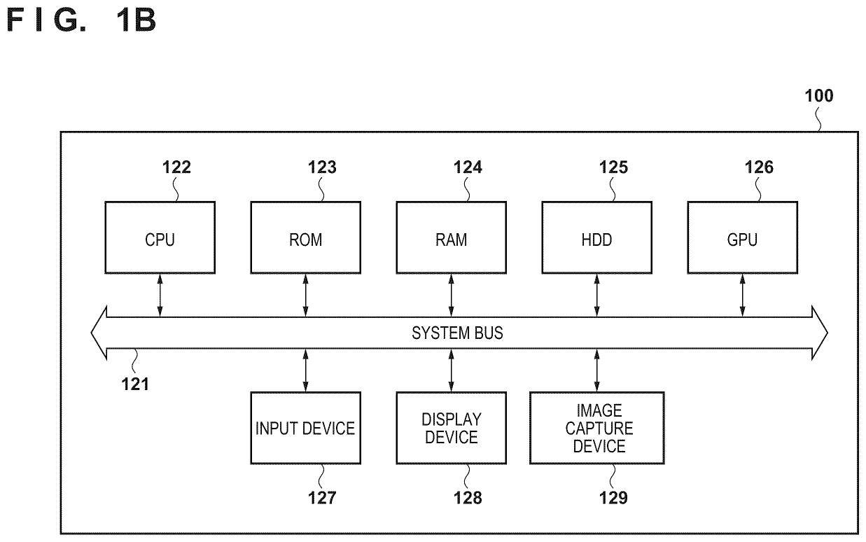

FIG. 1A is a diagram showing an example of the functional configuration of a digital camera 100 as an example of an image processing apparatus that generates image content according to an embodiment. An example of the hardware configuration of the digital camera will be described later with reference to FIG. 1B. Note that part or the entirety of the example of the functional configuration shown in FIG. 1A may be realized by, for example, a later-described CPU 122 or GPU 126 of the digital camera 100 executing a computer program.

The digital camera 100 includes, for example, an image content acquisition unit 101, a fluctuation element extraction unit 102, a fluctuation model generator 103, a fluctuation model database 104, and a content intent acquisition unit 105. Also, the digital camera 100 further includes a fluctuation rule determination unit 106, an image content reconstruction unit 107, a display unit 108, and a user instruction acquisition unit 109.

First, the image content acquisition unit 101 performs image content acquisition processing. In this embodiment, the image content acquisition unit 101 may not only acquire image content but also acquire meta information regarding the image content. Meta information regarding the image content includes, for example, information regarding the date and time when the image content is acquired, and acquisition position information.

The image content acquisition unit 101 controls acquisition of image content by an image capture device 129, which will be described later, and outputs the acquired image content to the fluctuation element extraction unit 102 and the image content reconstruction unit 107, which will be described later. The image content acquisition unit 101 may perform normalization by performing image processing such as any trimming and resizing on the image content in accordance with an output destination and then output the resulting image content.

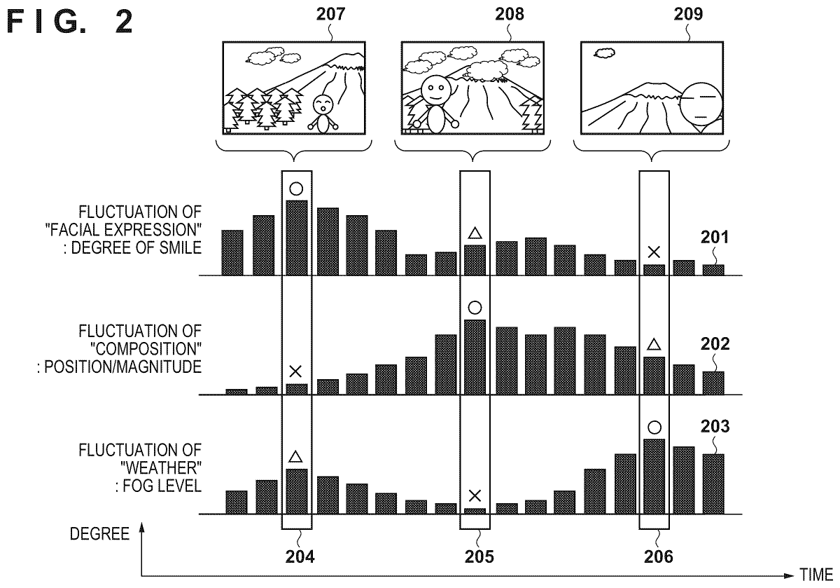

Here, “fluctuation” and “fluctuation elements” according to this embodiment will be described with reference to FIG. 2. FIG. 2 shows “fluctuation” of elements constituting image content. The time axis is shown on the horizontal axis, and the magnitude of the degree of the elements is shown on the vertical axis in FIG. 2. In FIG. 2, reference numerals 201, 202, and 203 indicate changes in elements constituting the image content on the time axis. For example, reference numeral 201 indicates a change in the “degree of a smile” in the “facial expression” of a main subject on the time axis. Reference numeral 202 indicates a change in the “composition position” on the time axis, and reference numeral 203 indicates a change in the “amount of clouds” in the “weather” on the time axis. In this embodiment, variations in the state of the elements constituting an image are referred to as “fluctuation”. For example, the variation (change) in the state of one element such as the degree of a smile will be described as “fluctuation”. Also, an element having “fluctuation” will be referred to as a “fluctuation element”. As for the fluctuation element, the degree of a state variation can be measured from the image content.

In the example shown in FIG. 2, a case where the shooting intent when a photographer shoots an image (i.e., an image content acquisition intent) is any one of a high “degree of a smile”, a subject present on the left side as a “composition position”, and a small “amount of clouds” will be described as an example.

The timings when the fluctuation of the fluctuation elements is the highest are the timing when the “degree of the smile” is reference numeral 204, the timing when the “composition position” is reference numeral 205, and the timing when the “amount of clouds”) is reference numeral 206. The image content acquired at the timings 204, 205, and 206 are respectively content 207, 208, and 209.

The fluctuation element extraction unit 102 extracts fluctuation elements included in the image content. For example, in an example in which the facial expression of a person is used as a fluctuation element, the fluctuation element extraction unit 102 extracts the fluctuation element by executing detection of the face of the person in the image content. The fluctuation element extraction unit 102 further performs fluctuation degree acquisition processing on the facial expression of the person in a case where the face of the person is detected. For example, the fluctuation element extraction unit 102 quantifies the degree of a smile, the degree of joy, anger, grief, and happiness, the degree of eye opening, the degree of mouth opening, and the like, through the degree acquisition. Note that when acquiring the degree of fluctuation, the degree of fluctuation may be calculated from the image content, or the degree of fluctuation corresponding to the image content may be acquired via a network.

Note that other fluctuation elements may include, for example, the posture of a person in image content, the composition of the image content, the lighting in the image content, the weather in the image content, the clothing of the subject in the image content, or the like. As for the posture of a person, the degree of fluctuation may be determined, for example, from at least any of the orientation of the face, the orientation of the body, the motion blur amount of the person, and the like. Also, as for the composition of the image content, the degree of fluctuation may be determined, for example, from at least any of the positional relationship between subjects, the distance between subjects, and the like. As for lighting, the degree of fluctuation may be determined, for example, from the position of a light source or the like. As for the weather, the degree of fluctuation may be determined, for example, from at least any of the weather, the amount of clouds, and the like. As for clothing, the degree of fluctuation may be determined, for example, from at least any of the type, color, and the like of the clothing. The fluctuation element extraction unit 102 outputs, to the fluctuation rule determination unit 106, the calculated degree of the fluctuation element together with the image content. Also, the fluctuation element extraction unit 102 outputs, to the fluctuation model generator 103, the image content and the degrees of fluctuation of the fluctuation elements as training data for a fluctuation model, which will be described later.

The fluctuation model generator 103 performs processing for training a learning model for each fluctuation element (referred to as a “fluctuation model” hereinafter) using the image content and the extracted degrees of fluctuation of the fluctuation elements that are obtained from the fluctuation element extraction unit 102. The fluctuation model is generated for each fluctuation element, and is trained to generate image content corresponding to a designated degree of fluctuation. For example, the fluctuation model in which the facial expression of a person is a fluctuation element is trained to generate image content having a designated facial expression. Note that, even for the same fluctuation element, a plurality of fluctuation models may be generated for each period such as every one month, for each region where a user has stayed, or in response to an instruction from the user.

The fluctuation models may be constructed using a known machine learning algorithm capable of generating an image, such as a GAN (Generative Adversarial Network). The GAN is constituted by two neural networks: a generator that generates image content, and a discriminator that discriminates whether or not the image content generated by the generator is a real image.

In fluctuation model training stage processing, the above-described generator and the above-described discriminator share a loss function with each other, and respectively and repeatedly update neural networks such that the generator minimizes the loss function and the discriminator maximizes the loss function. As a result, the image content generated by the generator will be a natural image. Note that well-known techniques are applied to the configurations of neural networks and the learning algorithm in the GAN, and thus will not be described in this embodiment. In this manner, the data used in training is stored in the fluctuation model database 104 in association with the trained fluctuation model. In other words, the image content included in the training data and the degree of the fluctuation element of the image content are stored in the fluctuation model database 104 in association with information indicating the fluctuation element (corresponding to the model).

The fluctuation model database 104 is stored in a later-described HDD 125, and stores a fluctuation model for each fluctuation element generated by the fluctuation model generator 103, and data used in training.

Note that, in this embodiment, a case where the fluctuation model generator 103 and the fluctuation model database 104 are included in the digital camera 100 will be described as an example. However, a configuration may be adopted in which a communication unit is provided in the digital camera 100, and the fluctuation model generator 103 and the fluctuation model database 104 are stored on an external server or cloud. Alternatively, the fluctuation model generator 103 and the fluctuation model database 104 may be stored in both the digital camera 100 and an external server, and may be used depending on the use or purpose.

For example, a database and a generator that generates a fluctuation model associated with a fluctuation element expected to be used frequently, such as the facial expression of the main subject, are provided on the digital camera 100 side. On the other hand, a generator that generates a fluctuation model that is used infrequently and a fluctuation model in the process of training, and training data may be stored on the external server side. Also, the update history of the fluctuation model may also be managed on the external server or the cloud service side.

The content intent acquisition unit 105 acquires a content acquisition intent that the photographer wishes to express in input image content, and outputs, to the fluctuation rule determination unit 106, the identifier of the content acquisition intent indicating the content acquisition intent.

In this embodiment, for example, a relationship between the fluctuation element included in the image content and the content acquisition intent identifier is determined in advance, and the fluctuation element included in the image content to be acquired is converted into the identifier of the content acquisition intent. That is, the content intent acquisition unit 105 can acquire the identifier of the content acquisition intent based on image information of the image content. The identifier of the content acquisition intent includes, for example, keywords used for tagging ordinary image content, such as “fun” and “commemorative picture”. Furthermore, the content intent acquisition unit 105 may receive an instruction or selection regarding the content acquisition intent identifier from the user. Also, the content intent acquisition unit 105 may estimate information of the content acquisition intent identifier from the user action history such as operation history and the number of shooting attempts performed to acquire image contents.

The content intent acquisition unit 105 may further output the content acquisition intent identifier using sound information. For example, by using sound information regarding a surrounding region at the time of content acquisition, the content intent acquisition unit 105 can also convert sound information regarding the shooting space including the voice of the photographer into a content acquisition intent identifier.

The fluctuation rule determination unit 106 calculates a fluctuation degree change amount for each fluctuation element (referred to as a “fluctuation rule” hereinafter) for the fluctuation element of image content to be reconstructed and the degree of the fluctuation element, using the above-described content acquisition intent identifier. Also, the fluctuation rule determination unit 106 designates a fluctuation model used for the image content reconstruction unit 107, which will be described later. Details of processing performed by the fluctuation rule determination unit 106 will be described later.

The image content reconstruction unit 107 reads the fluctuation model from the fluctuation model database 104 in accordance with the rule (the fluctuation degree change amount of the fluctuation element) determined by the fluctuation rule determination unit 106. Also, the image content reconstruction unit 107 reconstructs image content by inputting image content to be reconstructed and a parameter for reconstruction into the fluctuation model. Details of image content reconstruction will be described later. The image content reconstruction unit 107 outputs the reconstructed image content to the display unit 108.

The display unit 108 causes a display device 128 to display various image content. In this embodiment, the display unit 108 causes the display device 128 to display at least the image content acquired by the image content acquisition unit 101 or the image content reconstructed by the image content reconstruction unit 107.

The user instruction acquisition unit 109 receives various instructions regarding reconstruction of an image content from the user via an input device 127, and prompts each processing unit of the digital camera 100 to perform predetermined processing. For example, the user instruction acquisition unit 109 receives an image content acquisition instruction and a reconstruction instruction from the user. In addition, designation of parameters required for image content reconstruction, such as an identifier of a content acquisition intent and a fluctuation model, may also be received.

### Example of Hardware Configuration of Digital Camera

Next, an example of the hardware configuration of the digital camera 100 will be described later with reference to FIG. 1B. The digital camera 100 includes, for example, a system bus 121, a CPU 122, a ROM 123, a RAM 124, an HDD 125, a GPU 126, the input device 127, the display device 128, and the image capture device 129. Each unit of the digital camera 100 is connected to the system bus 121.

The CPU 122 is an arithmetic circuit such as a CPU (central processing unit) and realizes each function of the digital camera 100 by loading a computer program stored in the ROM 123 on the RAM 124 or the HDD 125 and executing the computer program. The ROM 123 includes, for example, a nonvolatile storage medium such as a semiconductor memory, and stores, for example, programs executed by the CPU 122 and necessary data. The RAM 124 includes, for example, a volatile storage medium such as a semiconductor memory, and temporarily stores, for example, the calculation results of the CPU 122 and the like. The HDD 125 includes a hard disk drive, and stores, for example, computer programs executed by the CPU 122, the results of processing performed by the CPU 122, and the like. Although a case where the digital camera 100 has a hard disk is described as an example, the digital camera 100 may have a storage medium such as an SSD, instead of the hard disk. The GPU (Graphics Processing Unit) 126 includes an arithmetic circuit, and can execute, for example, part or the entirety of training stage processing for the learning model and inference stage processing. The GPU can process more data in parallel, compared to the CPU, and thus effectively performs deep learning processing for repeatedly performing calculation using the above-described neural networks.

The input device 127 includes an operation member such as a button or a touch panel that receives an operation input made on the digital camera 100. The display device 128 includes, for example, a display panel such as an OLED. The image capture device 129 includes, for example, optical system units such as a lens, an aperture, and a shutter, and an image sensor such as a CMOS sensor. The optical system unit may be configured including a compound eye lens or a multi-eye lens. Also, optical properties, such as a zoom and the aperture, of an optical unit may be able to be changed (e.g., depending on an image content to be acquired).

### Fluctuation Model Training Processing

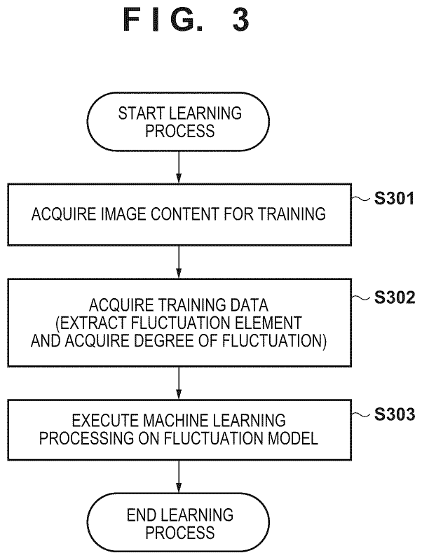

Fluctuation model training processing performed by the fluctuation model generator 103 or the like will be described with reference to FIG. 3. Note that this processing can be realized by the units shown in FIG. 1A, which are realized by, for example, the CPU 122 or GPU 126 of the digital camera 100 executing a computer program. Also, this processing can be basically executed at the timing when a shooting instruction is received from the user, and in any period before and after the timing. However, even in a case where no shooting instruction is received from the user, the processing may be executed at a certain interval, for example, in a case where the image content acquisition unit 101 is always activated and can shoot a surrounding environment of the photographer.

In step S301, the image content acquisition unit 101 acquires image content for training via the image capture device 129. For example, the acquired image content for training is still image data. Also, the image content acquisition unit 101 may cut out still image data from moving image content. The image content acquisition unit 101 outputs the acquired still image data to the fluctuation element extraction unit 102. Note that the image content to be acquired is not limited to image content output from the image capture device 129, and image content that has been acquired and stored in the HDD 125 in advance may be used. The image content for training may be limited to an image content acquired in a specific period or at a specific position. For example, the image content for training may image content acquired between a predetermined start instruction and an end instruction given by the user as a shooting period or a training data collection period. Alternatively, the image content for training may be acquired in accordance with image content to be reconstructed. The image content for training may be image content acquired in a predetermined period before and after the date and time when the image content to be processed for reconstruction is acquired. Alternatively, the image content for training may be image content acquired in a predetermined range around the position at which the image content to be processed for reconstruction is acquired.

In step S302, the fluctuation element extraction unit 102 extracts a predetermined fluctuation element from the input still image data, and calculates (acquires) the degree of fluctuation (score) for the extracted fluctuation element. The image content acquisition unit 101 normalizes the still image data in a region including the extracted fluctuation element, and outputs the normalized data together with information regarding the degree of fluctuation to the fluctuation model generator 103 (as training data for a fluctuation model).

Note that it is presumed that this processing is executed for each fluctuation element for one piece of still image data in this description. However, the frequency of extraction of fluctuation elements may be determined for each fluctuation element. For example, the extraction frequency may be set high for elements having a large fluctuation change, and the extraction frequency may be set low for elements having a small fluctuation change.

In step S303, the fluctuation model generator 103 reads information regarding a fluctuation model to be trained, from the fluctuation model database 104, and performs machine learning processing on the fluctuation model using the input training data. The machine learning processing for the fluctuation model is, for example, processing at the training stage of the GAN described above. Then, the fluctuation model generator 103 updates fluctuation model information in the fluctuation model database 104 together with data used in training. Note that, in a case where a fluctuation model to be trained is not present in the fluctuation model database 104, a new fluctuation model is added.

Fluctuation of the fluctuation elements in image content acquired by the user through the above processing or obtained through user experience is used as training data for each fluctuation element model. As a result, it is possible to construct a neural network of a GAN generator in which the fluctuation of the fluctuation element can be tuned (that is, it is possible to generate an image according to the designated degree of fluctuation).

### Operation of Reconstruction Processing

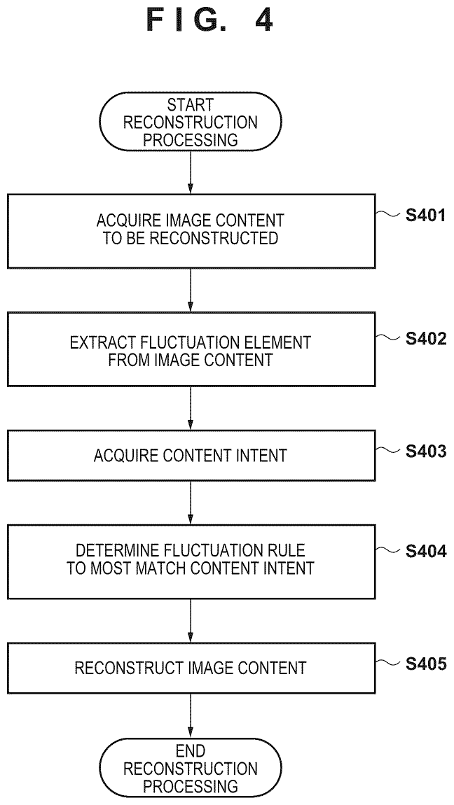

Next, image content reconstruction processing using the fluctuation element model will be described with reference to FIG. 4. Note that this processing can be realized by the units shown in FIG. 1A, which are realized by, for example, the CPU 122 or GPU 126 of the digital camera 100 executing a computer program. Note that this processing is started in response to receiving an instruction from the user. It is sufficient that one piece of image content to be reconstructed is selected to start processing, and the timing of the instruction may be any timing. This embodiment will be described presuming that the image content 208 shown in FIG. 2 is selected. For example, processing may be started in response to receiving a user instruction to acquire image content. In addition, a configuration may be adopted in which a reconstruction instruction is received while a recorded image is being displayed after the image content is acquired or when the image content is being reproduced.

In step S401, the image content acquisition unit 101 acquires image content to be reconstructed. Here, for example, a case where the image content 208 is image content to be reconstructed will be described as an example.

In step S402, the fluctuation element extraction unit 102 receives, from the image content acquisition unit 101, the image content to be reconstructed, extracts a fluctuation element included in the image content, and calculates (acquires) the degree of the fluctuation element. The operation of the fluctuation element extraction unit 102 is similar to that in the learning processing.

In step S403, the content intent acquisition unit 105 acquires the identifier of the content acquisition intent from any information group accompanying the image content. For example, an identifier of the content acquisition intent such as “travel”, “commemorative picture”, or “fun” is acquired from a person present in the image content 208, the facial expression thereof, and an object in the background, and is associated with the image content.

Note that the content intent acquisition unit 105 may acquire the identifier of the content acquisition intent based on further information other than the image content. For example, in a case where the digital camera 100 is provided with voice recognition technology, the content intent acquisition unit 105 uses the results of voice recognition to acquire the content acquisition intent identifier. For example, the content intent acquisition unit 105 may acquire the identifier of the content acquisition intent based on user utterance information recorded in a predetermined period before and after the image content is shot, or user utterance information input in a predetermined period after the image content is reproduced. Specifically, in a case where user's voice such as “it is cloudy”, “I cannot see because of clouds”, or “I wish it was sunny”, is recognized, when acquiring the image content 208 or giving a reconstruction instruction, the keyword may be “weather” or “sunny”, which is considered to be an ideal condition. In this case, this keyword is associated with the image content as a content acquisition intent identifier.

In addition to the above-described example, the identifier of the content acquisition intent may be predicted and calculated from user operation history information and action history information before and after the image content 208 selected in step S401 is shot, text information input by the user, and the like.

Then, the content intent acquisition unit 105 associates the content acquisition intent identifier with the image content 208 and outputs the content acquisition intent identifier to the fluctuation rule determination unit 106.

In step S404, the fluctuation rule determination unit 106 determines a fluctuation rule that serves as control information for the image content reconstruction unit 107, using the image content to be reconstructed, the fluctuation element information associated with the image content, and the content acquisition intent identifier.

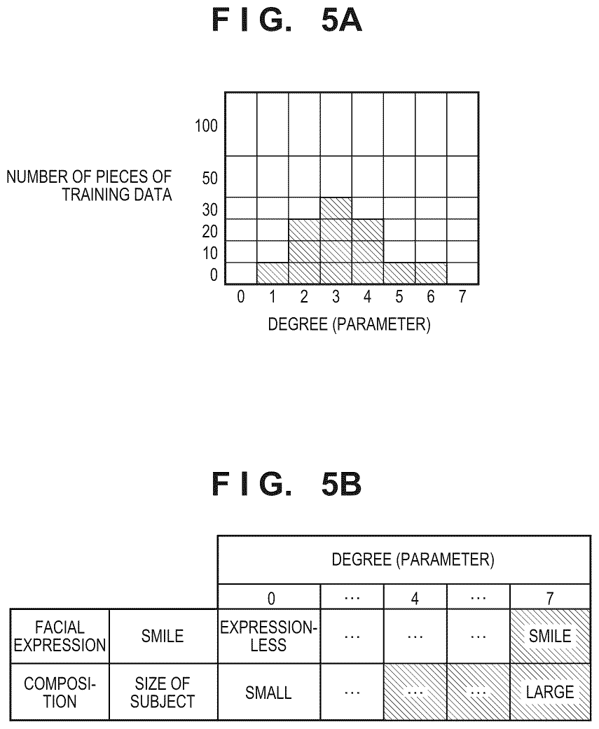

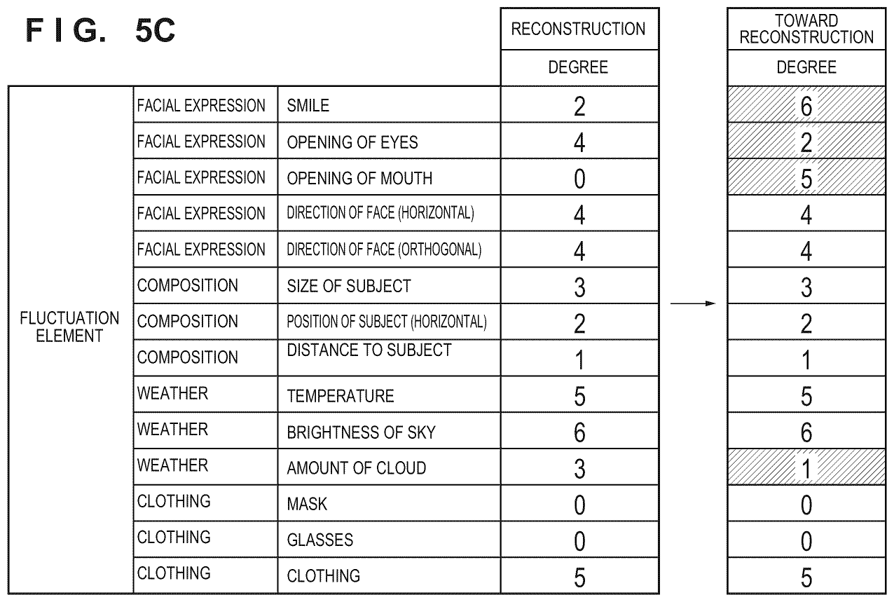

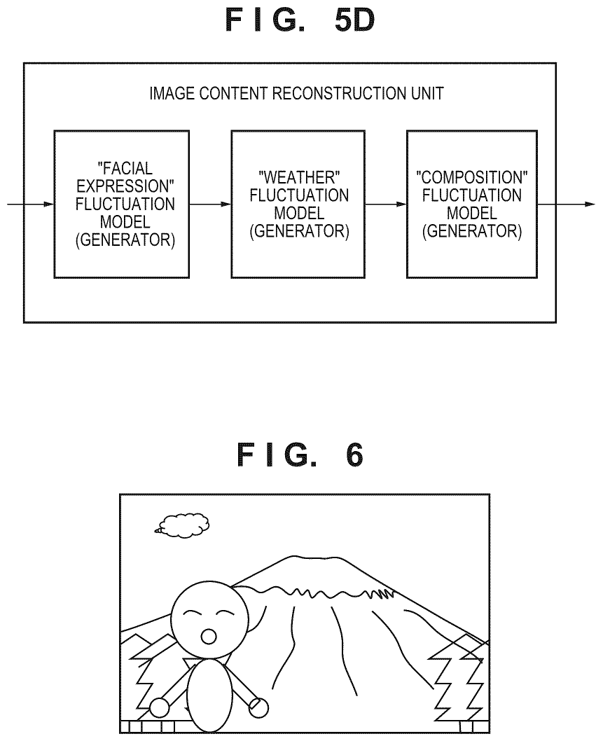

A method for creating a fluctuation rule according to this embodiment will be described with reference to FIGS. 5A to 5D. FIGS. 5A to 5D show a relationship between the degree of fluctuation of a fluctuation element of an image content to be reconstructed and various information.

The fluctuation rule determination unit 106 selects and reads, from the fluctuation model database 104, fluctuation model information associated with the fluctuation element of the image content 208 to be reconstructed. Note that fluctuation model information to be read is information regarding a fluctuation model trained using training data, and the training data includes at least the image content including the fluctuation element to be reconstructed.

The fluctuation rule determination unit 106 calculates information regarding a fluctuation range in which reconstruction is possible in the fluctuation model, using the read fluctuation model information and the associated training data group. For example, FIG. 5A shows an example of the distribution of training data for the fluctuation model regarding smiles. In the above-described GAN training, training is performed to generate an image with the degree of fluctuation included in the training data. Therefore, from the distribution of the degree of smiles in the training data shown in FIG. 5A, it is found that the fluctuation range of the image content that can be reconstructed by designating the degree of the fluctuation element is in a range of degrees 1 to 6.

Next, the fluctuation rule determination unit 106 calculates a recommended value of the degree of fluctuation of the fluctuation element after reconstruction, from the content acquisition intent identifier. In this embodiment, for example, the digital camera 100 stores information in which the above-described content acquisition intent identifier is associated with the ideal degree of fluctuation of the fluctuation element, as conversion table information regarding the intent and the ideal degree of fluctuation in advance. The fluctuation rule determination unit 106 calculates the degree of fluctuation of the fluctuation element after reconstruction, with reference to the conversion table information.

For example, as shown in FIG. 5B, the conversion table for the content acquisition intent identifier “fun” is associated with the fluctuation elements “facial expression” and “composition”. In this example, the ideal degree of fluctuation of the fluctuation element “facial expression” is associated such that the degree of a smile in the “facial expression” is 7, which is the maximum degree value.

The fluctuation rule determination unit 106 determines a fluctuation model to be used, and calculates a parameter set to the determined fluctuation model. The parameter to be set is calculated to be in the above-described fluctuation range in which reconstruction is possible and approach the ideal degree of fluctuation of the fluctuation element according to the content acquisition intent. For example, first, the fluctuation rule determination unit 106 determines whether the ideal degree of fluctuation corresponding to the shooting intent corresponds to a degree that can be set for reconstruction (whether the ideal degree is a degree of 1 to 6 in the above example), out of fluctuation degrees. In a case where the ideal degree of fluctuation corresponds to a degree that can be set for reconstruction, out of fluctuation degrees, the fluctuation rule determination unit 106 sets the ideal degree of fluctuation as the degree to be set for reconstruction. In a case where the ideal degree of fluctuation does not correspond to a degree that can be set for reconstruction, out of fluctuation degrees, the fluctuation rule determination unit 106 sets a degree that is the closest to the ideal degree, out of degrees that can be set for reconstruction as the degree to be set for reconstruction. That is, the adjusted degree adjusted in accordance with the ideal degree of fluctuation is set for reconstruction. For example, as shown in FIG. 5C, as for a parameter set in a fluctuation model for the fluctuation element “facial expression”, the ideal degree of fluctuation is degree 7, whereas the upper limit of the range in which a fluctuation model can be reconstructed is degree 6. Therefore, the value to be set is degree 6.

Further, the fluctuation rule determination unit 106 determines the order of reconstruction processes in which a plurality of fluctuation models are used. The fluctuation models are processed in any order, and the order of processes may be determined depending on various factors. In this embodiment, for example, processing is performed in the order of a fluctuation model having a larger difference between the above-described recommended value of the degree of fluctuation and the degree of fluctuation in the image content to be reconstructed, and then a fluctuation model having a smaller difference therebetween. In this case, for example, as shown in FIG. 5D, fluctuation model reconstruction processing is performed in the order of fluctuation models for first “facial expression”, then “amount of clouds”, and lastly “composition”.

The fluctuation rule determination unit 106 outputs, as a fluctuation rule, the fluctuation model information, the parameter information to be passed to the fluctuation models, and information regarding the fluctuation model reconstruction processing order to the image content reconstruction unit 107 in this manner.

In step S405, the image content reconstruction unit 107 executes reconstruction processing using the image content to be constructed and the fluctuation rule determined by the fluctuation rule determination unit 106. For example, an image such as that shown in FIG. 6 is generated as a result of reconstruction processing. The reconstructed image shown in FIG. 6 is a new image content in which the atmosphere of the image content 208 to be reconstructed is maintained, the “composition” thereof is not significantly changed, the degree of the smile in the “facial expression” is high, and the degree of the “amount of clouds” is low.

Note that a configuration may be adopted in which the generated image is displayed on the display unit 108 to prompt the user to check the image, and to receive feedback regarding reconstruction processing. For example, in a case where the user issues an instruction to record the reconstructed image content, recording processing may be performed and positive feedback may be given to the fluctuation model, otherwise, negative feedback may be given and new reconstruction processing may be performed.

As described above, in this embodiment, the degree of fluctuation of the fluctuation element of the acquired image content and information indicating the shooting intent of the user are acquired, and image content having different degrees of fluctuation are generated from the acquired image content using the trained leaning model. At this time, the learning model generates image content in which the degree of fluctuation acquired from the acquired image content corresponds to information indicating a shooting intent. Doing this makes it possible to obtain image content that more appropriately reflects a content acquisition intent.

According to the present invention, it is possible to obtain image content that more appropriately reflects a content acquisition intent.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising:
a content acquisition unit configured to acquire first image content;
a degree acquisition unit configured to acquire a degree of fluctuation of a fluctuation element of the first image content, the fluctuation element being an element having fluctuation as a state variation, out of elements constituting an image;
an intent acquisition unit configured to acquire information indicating a shooting intent of a user; and
a generation unit configured to generate second image content having a different degree of fluctuation of a fluctuation element of the image content from the first image content, using a trained learning model,
wherein the learning model generates the second image content in which the degree of fluctuation acquired from the first image content corresponds to the information indicating the shooting intent.

2. The image processing apparatus according to claim 1, wherein the intent acquisition unit acquires the information indicating the shooting intent based on image information of the first image content or based on at least one of text information input by the user, operation history information, action history information, and sound information, the information being information associated with the first image content.

3. The image processing apparatus according to claim 2, wherein the intent acquisition unit acquires the information indicating the shooting intent based on user utterance information in a predetermined period before and after the first image content is shot or in a predetermined period after the first image content is reproduced.

4. The image processing apparatus according to claim 1, further comprising a determination unit configured to determine whether the information indicating the shooting intent corresponds to a settable degree, out of degrees of fluctuation of a fluctuation element,
wherein the learning model generates the second image content in which the degree of fluctuation of the fluctuation element extracted from the first image content corresponds to the information indicating the shooting intent, in a case where the information indicating the shooting intent corresponds to the settable degree, out of the degrees of fluctuation of the fluctuation element.

5. The image processing apparatus according to claim 4, wherein the learning model generates the second image content in which the degree of fluctuation of the fluctuation element extracted from the first image content is an adjusted degree adjusted in accordance with information indicating the shooting intent, in a case where the information indicating the shooting intent does not correspond to the settable degree, out of the degrees of fluctuation of the fluctuation element.

6. The image processing apparatus according to claim 5, wherein the adjusted degree is a degree of fluctuation that is closest to a degree corresponding to the information indicating the shooting intent, out of settable degrees of the fluctuation element.

7. The image processing apparatus according to claim 4, wherein the determination unit determines whether the information indicating the shooting intent corresponds to the settable degree, based on a correspondence between a distribution of degrees of fluctuation of a plurality of pieces of image content used as training data for training the learning model and the information indicating the shooting intent.

8. The image processing apparatus according to claim 1, wherein the learning model is trained using training data including shot image content and a degree of fluctuation of a fluctuation element of the shot image content to generate image content in which the degree of fluctuation of the image content is a designated degree of fluctuation, from input image content.

9. The image processing apparatus according to claim 1, further comprising an image capture unit configured to shoot image content,
wherein training data for the learning model is data configured to include the image content shot by the image capture unit and a degree of fluctuation of a fluctuation element of the shot image content.

10. The image processing apparatus according to claim 1, wherein a plurality of pieces of image content used as training data for the learning model includes at least any of:
image content acquired between a predetermined start instruction and an end instruction given by the user;
image content acquired in a predetermined period before and after a date and time when an image content to be processed is acquired; and
image content acquired in a predetermined range around a position at which image content to be processed is acquired.

11. The image processing apparatus according to claim 1, wherein the fluctuation element of the image content includes at least one of a facial expression or a posture of a person in the image content, a composition of the image content, the weather found in the image content, and clothing of a subject found in the image content.

12. An image processing method to be executed in an image processing apparatus, comprising:
acquiring first image content;
acquiring a degree of fluctuation of a fluctuation element of the first image content, the fluctuation element being an element having fluctuation as a state variation, out of elements constituting an image;
acquiring information indicating a shooting intent of a user; and
generating second image content having a different degree of fluctuation of a fluctuation element of the image content from the first image content, using a trained learning model,
wherein the learning model generates the second image content in which the degree of fluctuation acquired from the first image content corresponds to the information indicating the shooting intent.

13. A non-transitory computer-readable storage medium which stores a program for causing a computer to execute a method, the method comprising:
acquiring first image content;
acquiring a degree of fluctuation of a fluctuation element of the first image content, the fluctuation element being an element having fluctuation as a state variation, out of elements constituting an image;
acquiring information indicating a shooting intent of a user; and
generating second image content having a different degree of fluctuation of a fluctuation element of the image content from the first image content, using a trained learning model,
wherein the learning model generates the second image content in which the degree of fluctuation acquired from the first image content corresponds to the information indicating the shooting intent.
